(19) United States
(12) Patent Application Publication
(10) Pub. No.: US 2018/0333000 A1
(43) Pub. Date: Nov. 22, 2018

(54) GRIDDLE PLATE SUSPENSION ASSEMBLY

(71) Applicant: Jiangmen City Xinhui Henglong Plastic Co. Ltd., Jiangmen (CN)

(72) Inventor: Huayao NIE, Jiangmen (CN)

(21) Appl. No.: 15/619,782

(22) Filed: Jun. 12, 2017

(30) Foreign Application Priority Data
May 22, 2017 (CN) 201710364353.3

(51) Int. Cl. A47J 37/06

(52) U.S. Cl. CPC A47J 37/0611; A47J 37/06; A47J 37/067

(57) ABSTRACT

A griddle plate suspension assembly having a housing, a griddle plate, a heating element arranged in the housing, a fastener connecting the housing with the griddle plate, and an elastic part pushing the heating element to the griddle plate. The griddle plate suspension assembly enables the griddle plate to be fixed relative to the location of the housing through the fastener, then enables the heating element to be fit to the griddle plate through the elastic extruding of the elastic part. In that way, heat generated by the heating element may be delivered to the griddle plate quickly and uniformly, thereby enabling quick and efficient increase in temperature of the griddle plate. The efficient heat conduction between the heating element and the griddle plate may effectively save the energy needed for baking the food.

### CROSS-REFERENCE TO RELATED APPLICATIONS

This application claims priority to Chinese Patent Application No. 201710364353.3 (filed May 22, 2017), which is hereby incorporated by reference in its entirety.

### TECHNICAL FIELD

Embodiments relate to the field of food baking and food processing, and particularly, relates to a griddle plate suspension assembly.

### BACKGROUND

Griddle plates for placing foods and heating elements for heating the griddle plates are needed by the existing baking devices used for baking bread, waffle, sandwich, hamburger and other pastries, and broiling barbecuing meat, vegetable and other food materials. A common method to fixedly connect the griddle plate and the heating element in the prior art is that: the griddle plate and the heating element are retained at two ends thereof through a fastener structure, a pressure spring is arranged between the griddle plate and the heating element to fix the locations of the two relatively; a gap between the griddle plate and the heating element is inevitable due to the middle elastic extruding of the pressure spring, and the gap will reduce the heat conducting performance of the heating element, decrease the cooking and baking efficiency of the griddle plate, and increases the heat amount needed by baking the food; due to the middle extruding of the pressure spring on the heating element and the griddle plate, it is difficult to keep the heating element and the griddle plate to be mutually parallel, the heat on the griddle plate is uneven, the cooked degrees of the food are different, and it is even possible to have the situation that parts of the food are not completely cooked or sear. Therefore, it is necessary to design a mechanism which is capable of baking the food more quickly and in a more energy-saving manner, and fitting the griddle plate and the heating element closely.

### SUMMARY

Embodiments are intended to solve the technical problems mentioned above by providing a griddle plate suspension assembly which is capable of baking the food more quickly and in a more energy-saving manner, and making the griddle plate fit the heating element closely to implement uniform heating.

Embodiments may be implemented through the following technical solutions.

A griddle plate suspension assembly comprises a housing, a griddle plate and a heating element arranged in the housing, and further comprises a fastener connecting the housing with the griddle plate, and an elastic part pushing the heating element to the griddle plate.

Preferably, the elastic part comprises a pressure spring/torsional spring connecting the housing with the heating element.

Preferably, the housing is provided with a retaining seat sheathing the pressure spring.

Preferably, the fastener comprises a recess arranged on the griddle plate and a bulge arranged on the housing and movably embedded in the recess.

Preferably, the bulge rotationally enters the recess, and the housing is provided with a tension spring pulling the bulge to enter the recess.

Preferably, the fastener comprises a lever with one end connected with the bulge, and a button pulling the other end of the lever to make the bulge leave the recess.

Preferably, the fastener comprises location holes arranged on the housing and location lugs arranged on the griddle plate and corresponding to the location holes.

Preferably, the griddle plate suspension assembly further comprises a stopper controlling the travelling (or can be referred as shift motion) of the heating element.

Preferably, the stopper comprises a guidepost passing through the heating element along the pushing direction of the elastic part, the guidepost is provided at one end thereof with a block piece, wherein the one end passes through the heating element, and the other end of the guidepost is connected with the housing.

Preferably, the heating element comprises a groove sinking towards the elastic part, and the block piece is located in the groove.

The advantageous technical effects are as follows: as compared with the prior art, the griddle plate suspension assembly of the present invention enables the griddle plate to be fixed relative to the location of the housing through the fastener, then enables the heating element to be fit to the griddle plate through the elastic extruding of the elastic part, so that the heat generated by the heating element can be delivered to the griddle plate quickly and uniformly, and the temperature of the griddle plate increases quickly. The efficient heat conduction between the heating element and the griddle plate can effectively save the energy needed for baking the food; and the heating element and the griddle plate can be suspended in the housing by the cooperation between the elastic part and the fastener, so that sufficient room for heat dissipation is provided between the heating element and the housing, which facilitates quick heat dissipation of the heating element during operation, so that the heating element is not easy to be damaged, and the service life of the product is prolonged.

### DRAWINGS

The specific embodiments of the present invention will be further described in details hereinafter with reference to the drawings, wherein:

FIG. 1 is a partial structure diagram of a baking device;

FIG. 2 is a structure diagram from FIG. 1 after removing a griddle plate;

FIG. 3 is a structure diagram from FIG. 2 after removing a heating element;

FIG. 4 is a section diagram of a griddle plate suspension assembly;

FIG. 5 is a structure diagram of another part of the baking device;

FIG. 6 is a partial enlarged diagram of part A in FIG. 5; and

FIG. 7 is a diagram illustrating a matching of the griddle plate, heating element and elastic part.

### DESCRIPTION

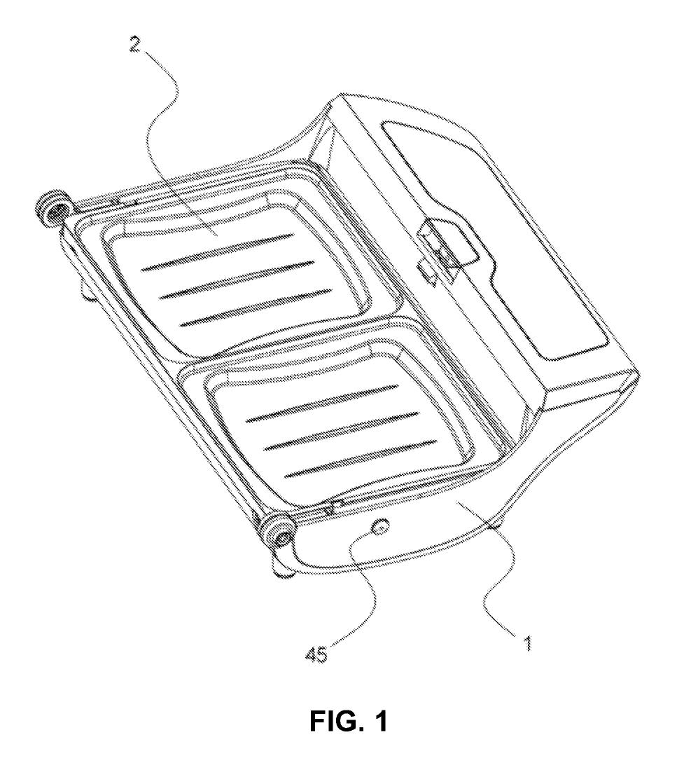

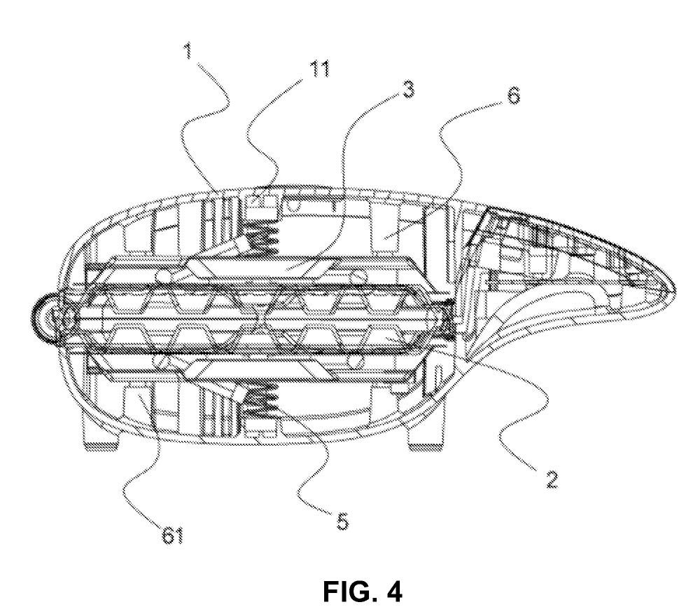

A griddle plate suspension assembly comprises a housing 1, a griddle plate 2 and a heating element 3 arranged in the housing 1, and further comprises a fastener 4 connected with the housing 1 and the griddle plate 2, and an elastic part 5 pushing the heating element 3 to the griddle plate 2. The griddle plate 2 is used for placing food materials. According to different food materials, there are a plurality of choices for the griddle plate 2, i.e., the griddle plate 2 may be a griddle plate for baking bread in FIG. 1, or a griddle plate 2 for baking waffle in FIG. 4, or an overall griddle plate 2 for broiling arranged on an unfolded housings 1 from an upper and lower housing part in FIG. 4.

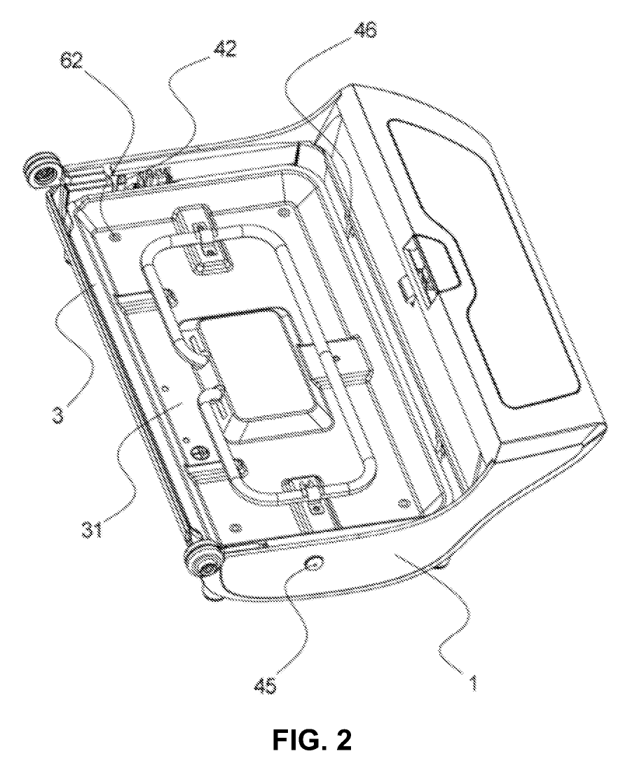

The heating element 3 may comprise a plate body and a heating tube arranged in the plate body shown in FIG. 2. The plate body may be internally provided with a groove 31 sinking backwards to the griddle plate 2. The heating tube is arranged in the groove 31, so that the heating tube may be not contacted with the griddle plate 2 directly, and the heat of the heating tube may be uniformly spread in the groove 31, which facilitates the uniform conduction of the heat of the griddle plate 2. A part of the plate body around the periphery of the groove 31 may be fit with the bottom of the griddle plate 2, which is intended to fix the locations of the griddle plate 2 and the heating element 3 as a whole. Under the matching of the elastic part 5 and the fastener 4, the griddle plate 2 and the heating element 3 can be fit closely.

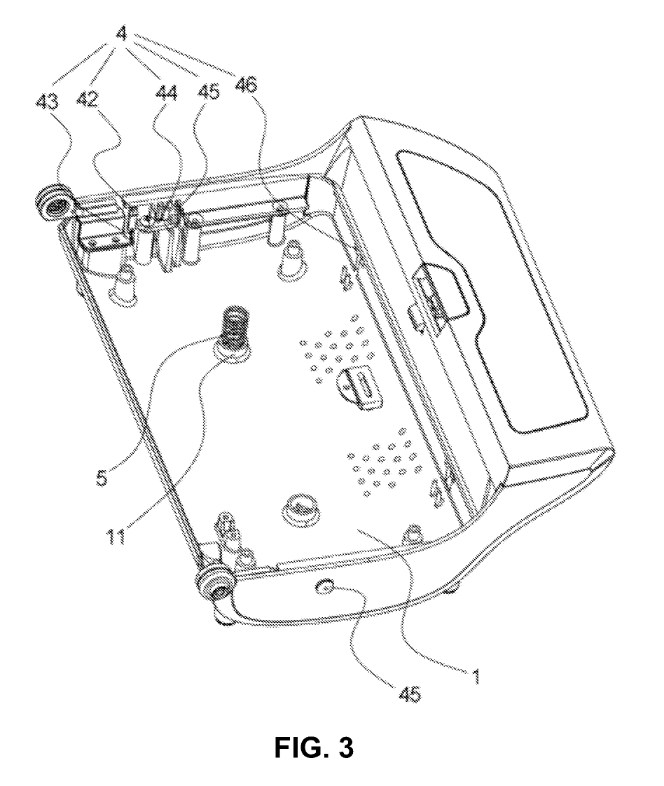

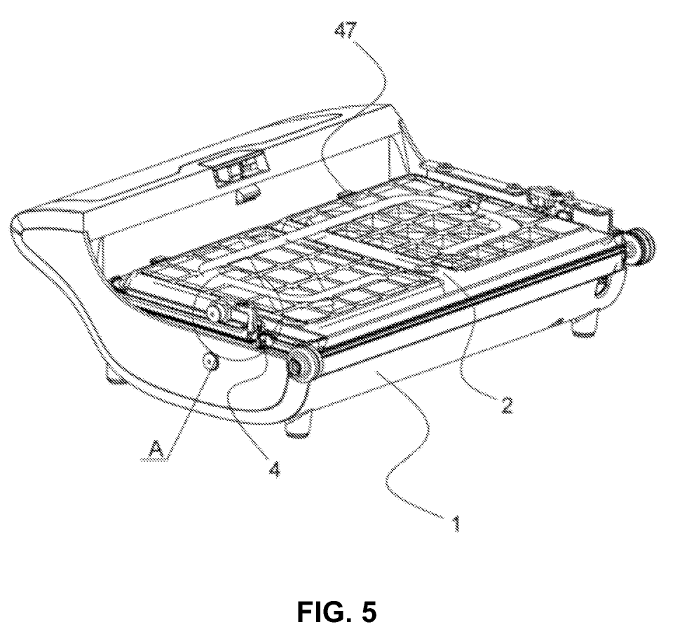

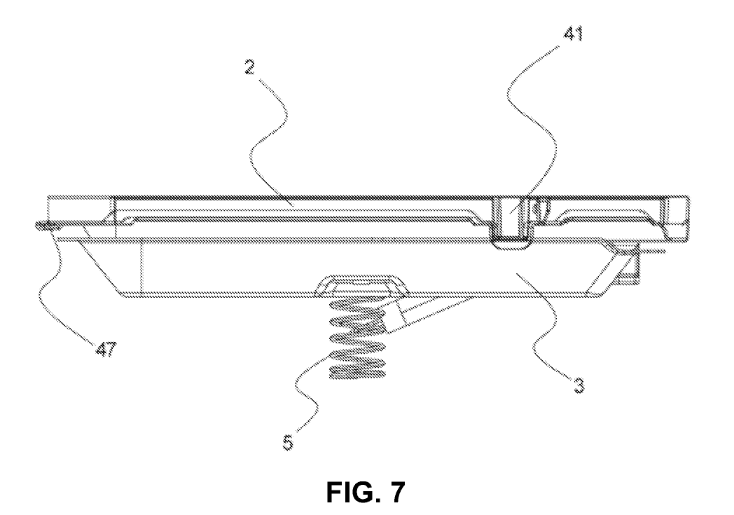

As shown in FIG. 3, FIG. 5 and FIG. 7, the elastic part 5 may comprise a pressure spring connecting the housing 1 with the heating element 3. The pressure spring may be arranged between the housing 1 at the bottom and the bottom surface of the heating element 3, wherein at least two pressure springs may be arranged between the housing 1 at the bottom and the bottom surface of the heating element 3. The housing 1 at the bottom may be provided with a retaining seat 11 sheathing the pressure spring, and the bottom surface of the heating element 3 may be provided with a recess for the pressure spring to embed in. The heating element 3 can be fit with the griddle plate 2 closely through the thrust of the pressure spring, and the pressure spring can locate its two ends through the matching of the retaining seat 11 and the recess, so that the thrust of the pressure spring is stable and the pressure spring may not displace.

The elastic part 5 may comprise a torsional spring connecting the housing 1 with the heating element 3. Two ends of the torsional spring are respectively connected with the housing 1 and the bottom of the heating element 3. The ordinary state of the torsional spring is a compressed state, and preferably, torsional springs are uniformly arranged around the heating element 3.

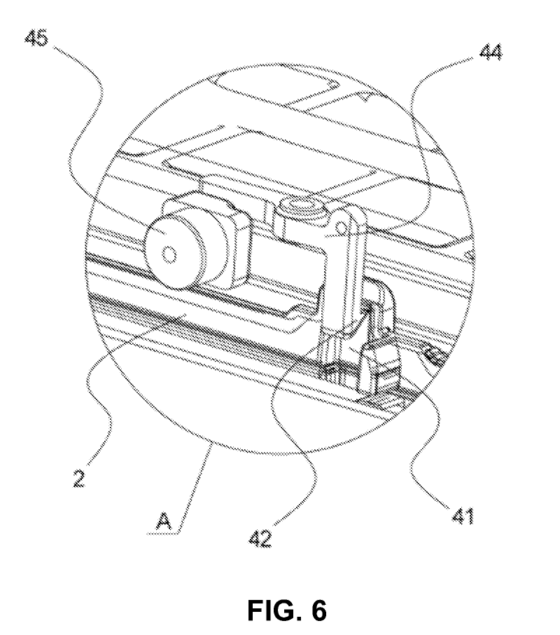

As shown in FIG. 1 to FIG. 7, the fastener 4 may comprise a recess 41 arranged on the griddle plate 2, and a bulge 42 arranged on the housing 1 and movably embedded in the recess 41. The bulge 42 may enter or leave the recess 41 through a rotational or translational manner. When the bulge 42 rotationally enters the recess 41, the housing 1 may be provided with a tension spring 43 pulling the bulge 42 to enter the recess 41. One end of the tension spring 43 may be fixed on the housing 1, and the other end is connected with the end of the lever 44 provided with the bulge 42. The effect of the tension spring 43 is to make the bulge 42 buckled in the recess 41 under the ordinary state, in this way, the griddle plate 2 is fixed on the housing 1 under the ordinary state. The fastener 4 may further comprise a lever 44 with one end connected with the bulge 42, and a button 45 pulling the other end of the lever 44 to make the bulge 42 leave the recess 41, wherein the button 45 may be manually pressed by a user to make the lever 44 rotate, the lever 44 stretches the tension spring 43 to make the bulge 42 leave the recess 41, in this way, the griddle plate 2 may be taken out for replacement, and the griddle plate 2 for baking waffle may be replaced with the griddle plate 2 for baking sandwich or the overall griddle plate 2. When the bulge 42 enters the recess 41 through the translational manner, the fastener 4 may comprise a rotary knob driving the bulge 42 to enter or leave the recess 41 through a rotational thread propulsion manner.

As shown in FIG. 2, FIG. 3 or FIG. 7, the fastener 4 may comprise location holes 46 arranged on the housing 1, and location lugs 47 arranged on the griddle plate 2 and corresponding to the location holes 46. The setting of the location holes 46 and the location lugs 47 is to provide preliminary location before fixing the griddle plate 2 on the housing 1 through the bulge 42 and the recess 41. A specific operation may be that, the location lugs 47 on the griddle plate 2 are buckled in the location holes 46 on the housing 1 firstly, then the griddle plate 2 is entirely arranged on a corresponding location of the housing 1, so that the recess 41 on the griddle plate 2 can be buckled with the bulge 42 on the housing 1, and the settings of the successive two steps enables the griddle plate 2 to be removably fixed with the housing 2 quickly and stably.

The griddle plate suspension assembly may further comprise a stopper 6 controlling the travelling of the heating element 3. The setting of the stopper 6 can control and restrict the travelling of movement of the heating element 3 induced by the action of the elastic part 5 onto the heating element 3, so that the heating element 3 may not be ejected out from the housing 1. Through the control over the travelling, the stopper 6 can make the elastic part 5 be always in a compressed state to give enough pre-tightening force to the heating element 3. When the griddle plate 2 is fixed through the fastener 4 to press the heating element 3, the elastic part 5 is capable of providing enough pressure to make the heating element 3 be fit with the griddle plate 2 closely. When replacing the griddle plate 2, the heating element 3 may also be slightly pushed downward through the guiding of the stopper 6 to leave space in the housing 1 for replacing the griddle plate 2.

As shown in FIG. 2 and FIG. 4, the stopper 6 may comprise a guidepost 61 passing through the heating element 3 along the pushing direction of the elastic part 5, the guidepost 61 is provided at one end thereof with a block piece 62, wherein the one end of the guidepost 61 passes through the heating element 3, and the other end of the guidepost 61 is connected with the housing 1. The guidepost 61 may be connected with the housing 1 through a thread, the housing 1 is provided with a threaded hole, the guidepost 61 is provided at one end thereof towards the housing 1 with a thread matched with the threaded hole, and the other end of the guidepost 61 is a smooth surface for providing shift guiding for the heating element 3. The heating element 3 may comprise a groove 31 sinking to the elastic part 5, the block piece 62 is located in the groove 31, the heating element 3 moves relative to the guidepost 61, while the block piece 62 moves in the groove 31. If the bottom surface of the griddle plate 2 is level, the depth of the groove 31 is just the travel range of the heating element 3 relative to the guidepost 61. The bottom of the griddle plate 2 may also be provided with a blind hole accommodating the block piece 62, in this way, the block piece 62 can enter the blind hole after its travel exceeding the depth of the groove 31.

When the elastic part 5 is a pressure spring, the pressure spring may be sheathing the guidepost 61. Preferably, the guideposts 61 are uniformly arranged on four corners of the heating element 3.

Alternatively, the heating element 3 may not be provided with the groove 31, and the movement of the block piece 62 is allowed only by the blind hole that may be arranged on the bottom of the griddle plate 2 when the heating element 3 moves relative to the guidepost 61.

A griddle plate suspension assembly is shown in FIG. 1 to FIG. 7, which is a partial structure in the baking device. A housing 1 may comprise an upper part and a lower part which is capable of rotate relative to each other. Both the two parts of the housing 1 are provided with a griddle plate 2, a heating element 3, a fastener 4, an elastic part 5 and a stopper 6. By covering and folding the two parts of the housing 1, the two griddle plates 2 of the baking device are enabled to finish the enclosed baking of bread, sandwich, waffle and other pastries. By relative rotating of the two parts of the housing 1, the upper part and the lower part are unfolded to be level, open baking of meat, vegetable and other food materials can be done. Due to the setting of the fastener 4, the griddle plate 2 may be set as two independent plates respectively arranged on the upper part and the lower part, and may also be set as an overall plate covering the upper part and the lower part at the same time, wherein the overall plate can bake more foods at the same time relative to the independent plates.

The embodiments above are not limited to the technical solutions of the embodiments thereof, and the embodiments may be mutually combined to form new embodiments. The embodiments above are only used for illustrating the technical solutions of the invention instead of limiting the invention. Any amendment or equivalent replacement not departing from the scope of the invention shall all fall with the scope of the technical solutions of the invention.

What is claimed is:

1. A griddle plate suspension assembly, comprising:
a housing;
a griddle plate;
a heating element arranged in the housing; and
a fastener connecting the housing with the griddle plate; and
an elastic part pushing the heating element to the griddle plate.

2. The griddle plate suspension assembly of claim 1, wherein the elastic part comprises a pressure spring/torsional spring connecting the housing with the heating element.

3. The griddle plate suspension assembly of claim 2, wherein the housing is provided with a retaining seat sheathing the pressure spring.

4. The griddle plate suspension assembly of claim 1, wherein the fastener comprises a recess arranged on the griddle plate, and a bulge arranged on the housing and movably embedded in the recess.

5. The griddle plate suspension assembly of claim 4, wherein the bulge rotationally enters the recess, and the housing is provided with a tension spring pulling the bulge to enter the recess.

6. The griddle plate suspension assembly of claim 5, wherein the fastener comprises a lever with one end connected with the bulge, and a button pulling the other end of the lever to make the bulge leave the recess.

7. The griddle plate suspension assembly of claim 1, wherein the fastener comprises location holes arranged on the housing and location lugs arranged on the griddle plate and corresponding to the location holes.

8. The griddle plate suspension assembly of claim 1, comprising a stopper configured to control movement of the heating element.

9. The griddle plate suspension assembly of claim 8, wherein the stopper comprises a guidepost passing through the heating element along the pushing direction of the elastic part.

10. The griddle plate suspension assembly of claim 9, wherein the guidepost is provided at one end thereof with a block piece.

11. The griddle plate suspension assembly of claim 10, wherein a first end of the guidepost passes through the heating element, and a second end of the guidepost is connected to the housing.

12. The griddle plate suspension assembly of claim 11, wherein the heating element comprises a groove sinking towards the elastic part.

13. The griddle plate suspension assembly of claim 12, wherein the block piece is located in the groove.
